(19) United States
(12) Patent Application Publication
(10) Pub. No.: US 2004/0175472 A1
(43) Pub. Date: Sep. 9, 2004

(54) Apparatus and method for protecting stored wine against exposure to air

(76) Inventor: Sandor Sujto, St. Helena, CA (US)

Correspondence Address: Donald Diamond, 2nd Floor, 2180 Jefferson Street, Napa, CA, 94559-1200, US

(21) Appl. No.: 10/383,287

(22) Filed: Mar. 6, 2003

(51) Int. Cl. C12H 1/10

(52) U.S. Cl. 426/321

(57) ABSTRACT

An apparatus and method for protecting against oxidation wine stored in an open-mouth container. The apparatus includes a weight-activated piston covering the mouth which maintains contact with the wine surface, and a valve which expels air from the container as the volume of wine slowly decreases.

### BACKGROUND OF THE INVENTION

1. Field of the Invention

The present invention relates to protecting wine against oxidation and spoilage resulting from ullage in aging and other storage containers. More particularly, the invention is an apparatus for maintaining such containers in a full state, including a weight-activated piston totally covering and contacting the liquid surface, and a method for implementing the apparatus.

2. Description of the Related Art

Protracted oxidation is harmful to the color, taste, composition and quality of wine. Consequently, prevention of oxidation and resultant spoilage due to prolonged air contact is a major concern during wine production, aging and storage. A common practice is to minimize oxidation by periodically adding wine to “top up” a container so as to reduce or temporarily eliminate the ullage (i.e., the amount by which the container falls short of being full) which develops as volume becomes depleted due to evaporation, seepage, sampling and the like. This process can be time consuming and costly, and exposes the wine to air each time the container is opened.

U.S. Pat. No. 5,976,583 to E. P. Mastrocola is directed to an apparatus and method for maintaining a peak level of wine aging in a container such as a barrel or cask. A tube running through a bung in the container is in fluid comunication with a wine reservoir suspended over the container. Wine flowing from the reservoir through the tube and into the container replaces any evaporating or otherwise escaping wine. A single reservoir can supply wine to a plurality of containers by using a corresponding plurality of tubes, each passing, respectively, through a bung in each container.

U.S. Pat. No. 4,211,115 to R. N. Engebreth discloses an inflatable bladder within a wine aging container which is free of contact with the container inner surface and in fluid communication with a reservoir of water disposed above the container. Water entering the bladder causes it to expand, replacing any lost volume of wine. A valve allows air displaced by the expansion to escape from the container. A single reservoir can protect a plurality of containers by delivering water through manifold ducts with branch lines each connected to a bladder inside a container.

Both references teach using a reservoir external to a container to provide a liquid infusion which compensates for the ullage. However some wine-makers may view such reservoirs to be undesirable because of space constraints within an aging room if they opt to stack containers vertically, or because they fear the possibility of leakage such as might occur, for example, following an earthquake in northern California impacting the Napa and Sonoma valleys.

### OBJECTS OF THE INVENTION

In view of the foregoing considerations, it is an object of the present invention to provide an apparatus for eliminating ullage in a wine container, such as a wooden barrel, a metallic tank lined with wood, or a thermoplastic tank, which is securely integrated with the container, and a method for implementing the same.

Another object of the invention is to eliminate the need for manually topping off wine containers.

Still another object of the invention is to enable wine to be stored without ullage in each of a plurality of containers connected in series.

Other objects of the invention will become evident when the following description is considered with the accompanying drawings.

### SUMMARY OF THE INVENTION

These and other objects are met by the present invention which in a first aspect provides an apparatus for protecting against oxidation wine stored in a container having an open mouth and determined by a wall with an interior surface, and a bottom having an outlet. The apparatus includes: a piston covering the mouth and in slidable contact with the interior surface; a weight in contact with the piston; and a valve extending through the piston and in communication with the container interior.

In a second aspect the invention provides an apparatus for protecting against oxidation wine stored in a container having an open mouth and determined by a generally cylindrical wall with an interior surface, and a bottom having an outlet. The apparatus includes a cylindrical piston determined by parallel, circular upper and lower faces, and a peripheral surface orthogonal to the faces and circumscribed by an O-ring assembly having upper and lower O-rings in slidable contact with the interior surface. The apparatus further includes a rod orthogonal to the piston faces having a circular cross-section and a lower end attached to the piston upper face. The apparatus further includes a cylindrical weight having a bore therethrough which closely receives the rod so that the weight contacts the piston upper face. The apparatus further includes a valve orthogonal to the piston faces, extending through the piston, which has a lower end proximate to the piston lower face.

In a third aspect the invention provides a method for protecting against oxidation wine stored in a container having an open mouth and determined by a wall with an interior surface, and a bottom having an outlet. The method includes: (a) covering the container mouth with a weight-activated piston in slidable contact with the interior surface; (b) removing air displaced from the container when the piston initially moves downward until it contacts the wine surface; and (c) maintaining contact between the piston and wine surface, and removing air displaced thereby, as the volume of wine gradually decreases.

These and other features and advantages of the invention will become further apparent from the detailed description that follows, which is accompanied by drawing figures. In the figures and description, numerals indicate the various features of the invention, like numerals referring to like features throughout both the drawings and description.

### BRIEF DESCRIPTION OF THE DRAWINGS

FIG. 1 schematically shows a cross-section of an apparatus according to the invention integrated with a wine container, the apparatus including a weight-activated piston covering the container mouth, and an air valve.

FIG. 1A is a cut-away perspective of the FIG. 1 apparatus and container.

FIG. 2 schematically shows an outlet of the FIG. 1 container connected to the first of a plurality storage containers connected in series.

### DESCRIPTION OF THE PREFERRED EMBODIMENT

While the present invention is open to various modifications and alternative constructions, the preferred embodiment shown in the drawings will be described herein in detail. It is to be understood, however, there is no intention to limit the invention to the particular form disclosed. On the contrary, it is intended that the invention cover all modifications, equivalences and alternative constructions failing within the spirit and scope of the invention as expressed in the appended claims.

As used herein, the word “container” means a wooden barrel, a metallic tank lined with wood, or a thermoplastic tank. Where used herein, the word “attached” means that the two parts referred to (e.g., the piston and rod) are joined in a permanent combination, preferably by welding. Where used herein, the word “connected” means that the two parts referred to (e.g., a tube or pipe end inserted into a rubber stopper) are not permanently joined.

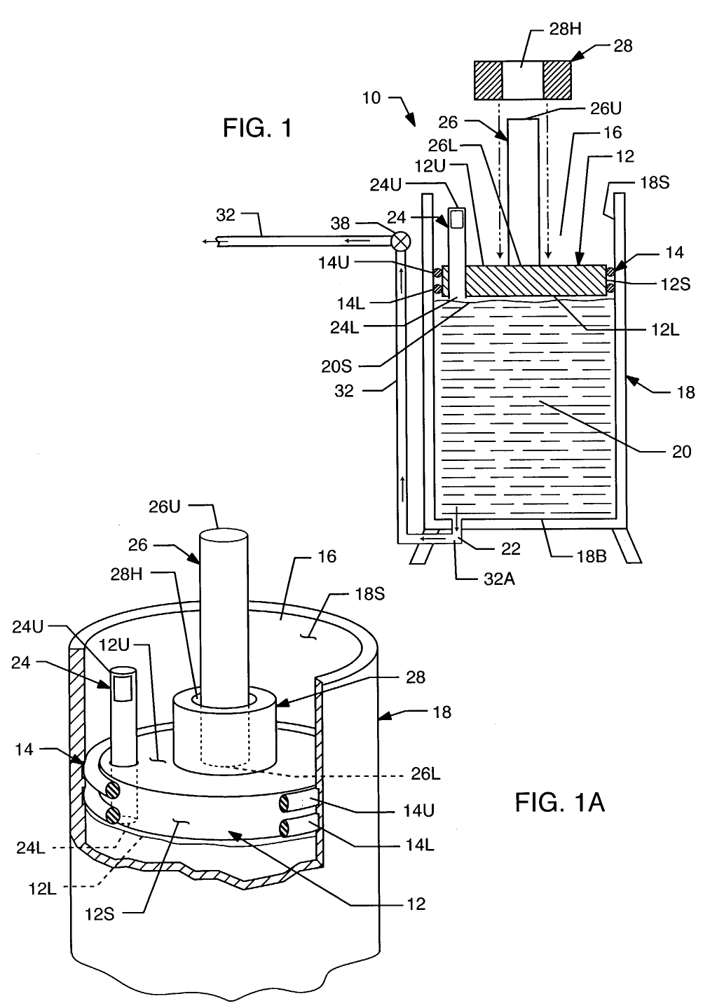

Referring to FIGS. 1 and 1A, an apparatus 10 according to the invention includes a generally cylindrical piston 12 determined by generally parallel, generally circular upper and lower faces 12U, 12L, respectively, and a peripheral surface 12S generally orthogonal to faces 12U, 12L. Surface 12S is circumscribed by a double O-ring assembly 14 having upper and lower O-rings 14U, 14L, respectively, which are closely received within the open mouth 16 of a generally cylindrical container 18 filled to a preselected level with a quantity of wine 20 having an upper surface 20S, and are in slidable contact with the interior surface 18S of the container. Container 18 has a bottom 18B with an outlet 22. Piston 12 has therethrough an air valve 24 having an upper end 24U, and a lower end 24L which terminates proximate to face 12L. A rod 26 with a generally circular cross-section of a preselected diameter and having upper and lower ends 26U, 26L, respectively, is attached at end 26L to face 12U so that the centers of the rod end and face are generally congruent. Rod 26 is closely received by and passes through generally circular bore 28H of a generally cylindrical weight 28, so that the weight rests on face 12U. Preferably, valve 24 is disposed sufficiently close to the periphery of piston 12 that there is sufficient clearance between the valve and weight to allow the weight to move down the rod onto the piston without interference.

After container 18 is filled with wine to a preselected level, weight 28 exerts a gravitational force on piston 12, causing the piston to move downward until face 12L contacts surface 20S. Air compressed by the downward motion of the piston is expelled through valve 24. As the wine ages and ullage gradually develops, the piston lowers corespondingly so that face 12L remains in contact with surface 20S.

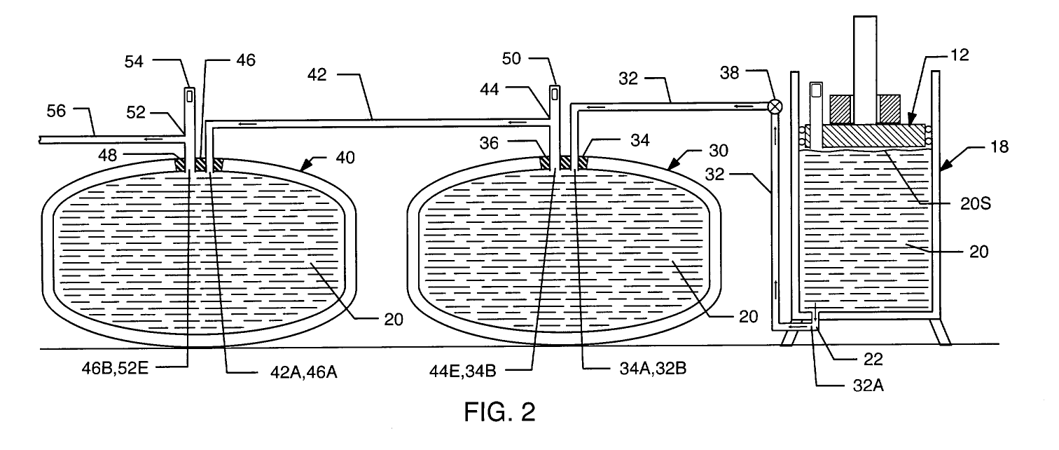

Referring to FIGS. 1 and 2, container 18 is in fluid communication with a first storage container 30 by means of piping 32 connected at an end 32A to outlet 22, and at an end 32B inserted through a first hole 34A of a stopper 34 disposed in a bung 36 of the container 30. Installed within the piping 32 is an adjustable valve 38 to regulate the rate at which wine flows from container 18 into container 30. Referring to FIG. 2, container 30 is in fluid communication with a second storage container 40 by means of piping 42 terminating in a T-joint 44 inserted at an end 44E through a second hole 34B of stopper 34, and inserted at an end 42A through a first hole 46A of a stopper 46 disposed in a bung 48 of container 40. T-joint 44 bifurcates in an air valve 50. Stopper 46 has a second hole 46B through which is inserted an end 52E of a T-joint 52 which bifurcates in an air valve 54 and a piping 56. Preferably, the stoppers are made of a hard rubber. In this manner a plurality of storage containers substantially filled with wine 20 can be connected in series. With valve 38 open, wine will flow into container 30 through piping 32 when sufficient hydrostatic pressure is exerted by piston 12 on surface 20S. This will cause the wine within container 30 to be topped out and the air displaced by the added wine to be expelled through valve 50. With container 30 filled to capacity, additional wine entering the container will cause the excess to flow via piping 42 into container 40. In this manner a series of storage containers can be maintained at peak capacity and prevented from developing ullage.

What is claimed is:

1. An apparatus for protecting against oxidation wine stored in a container having an open mouth and determined by a wall with an interior surface, and a bottom having an outlet, comprising:
a piston covering the mouth and in slidable contact with the interior surface;
a weight in contact with the piston; and
a valve extending through the piston and in communication with the interior of the container.

2. An apparatus for protecting against oxidation wine stored in a container having an open mouth and determined by a generally cylindrical wall with an interior surface, and a bottom having an outlet, comprising:
a generally cylindrical piston determined by generally parallel, generally circular upper and lower faces, and a peripheral surface generally orthogonal to the faces and circumscribed by an O-ring assembly having upper and lower O-rings in slidable contact with the interior surface of the container wall;
a rod generally orthogonal to the piston faces and having a generally circular cross-section of a preselected diameter and a lower end attached to the piston upper face;
a generally cylindrical weight having a bore therethrough which closely receives the rod, the weight contacting the piston upper face; and
a valve generally orthogonal to the piston faces and extending through the piston, the valve having a lower end proximate to the piston lower face.

3. The apparatus of claim 2 wherein said outlet is in fluid communication with a first storage container.

4. The apparatus of claim 3 wherein said first storage container is in fluid communication with a plurality of storage containers connected in series.

5. A method for protecting against oxidation wine stored in a container having an open mouth and determined by a wall with an interior surface, and a bottom having an outlet, comprising the steps of:
covering the container mouth with a weight-activated piston in slidable contact with said interior surface;
removing air displaced from the container when the piston initially moves downward until it contacts the wine surface; and
maintaining contact between the piston and wine surface, and removing air displaced thereby, as the volume of wine gradually decreases.

6. The method of claim 5 further comprising the step of:
transferring wine through piping connected to said outlet to a storage container pre-filled with wine which is in fluid communication with a plurality of storage containers connected in series.
